(19) United States
(12) Patent Application Publication
(10) Pub. No.: US 2010/0040041 A1
(43) Pub. Date: Feb. 18, 2010

(54) SWITCHING ROLE OF APPARATUSES BETWEEN CONTROLLER (HOST) AND PARTICIPANT (DEVICE) TO SCHEDULE BI-DIRECTIONAL DATA

(75) Inventors: Christian Zechlin, Herne (DE); Thomas Block, Wuppertal (DE)

Correspondence Address: BANNER & WITCOFF, LTD., 1100 13th STREET, N.W., SUITE 1200, WASHINGTON, DC, 20005-4051, US

(73) Assignee: Nokia Corporatioin, Espoo (FI)

(21) Appl. No.: 12/532,446

(22) PCT Filed: Mar. 22, 2007
(86) PCT No.: PCT/IB07/01856

§ 371 Date: Oct. 20, 2009

(51) Int. Cl. H04B 7/212; H04H 20/71

(52) U.S. Cl. 370/347; 455/3.05

(57) ABSTRACT

A method involving: sending from a first apparatus to a second apparatus a first message identifying the first apparatus and a second message scheduling a time period for reply; receiving at the first apparatus during the time period scheduled by the second message a third message sent by the second apparatus; and in response to receiving the third message, changing a role of the first apparatus so that it is operable to schedule bi-directional data transfer between the first apparatus and the second apparatus.

### FIELD OF THE INVENTION

Embodiments of the present invention relate to methods, apparatus and computer program products. In particular, they relate to role changing within a wireless network, for example, a Certified Wireless USB network.

### BACKGROUND TO THE INVENTION

Networks, particularly wireless networks, may have a star topography in which a single apparatus at the center of the star controls the network and communicates which each of the other participant apparatuses in the network which do not typically communicate with each other. It may be desirable to change the role of one apparatus from controller to participant. It may be desirable to swap the roles of a controller apparatus and a participant apparatus.

As an illustrative and non-limiting example, in Certified Wireless USB, when a first apparatus connects to a second apparatus, the first apparatus assume the role of participant (device) and the second apparatus assumes the role of controller (host). The controller (host) schedules bi-directional data communication between the first and second apparatus. It would therefore be desirable to be able to change the role of the first apparatus to controller (host) so that it may schedule bi-directional data communication between the first apparatus and the second apparatus.

### BRIEF DESCRIPTION OF THE INVENTION

According to some embodiments of the invention there is provided a method comprising: sending from a first apparatus to a second apparatus a first message identifying the first apparatus and a second message scheduling a time period for reply; receiving at the first apparatus during the time period scheduled by the second message a third message sent by the second apparatus; and in response to receiving the third message, changing a role of the first apparatus so that it is operable to schedule bi-directional data transfer between the first apparatus and the second apparatus.

According to some embodiments of the invention there is provided an apparatus comprising: means for transmitting a first message identifying the apparatus and a second message scheduling a time period for reply; means operable, during the time period scheduled by the second message, to receive a third message and, in response to receiving the third message to enable the apparatus to schedule bi-directional data transfer.

According to some embodiments of the invention there is provided a computer program product comprising: means for enabling transmission of a first message identifying an apparatus storing the computer program product and a second message scheduling a time period for reply; and means for enabling the apparatus to schedule bi-directional data transfer in response to receipt by the apparatus of a third message during the time period scheduled by the second message.

According to some embodiments of the invention there is provided a method comprising: receiving at a second apparatus a first message identifying a first apparatus and a second message scheduling a time period for reply; sending, during the time period scheduled by the second message, from the second apparatus to the first apparatus, a third message; and changing a role of the apparatus so that bi-directional data transfer between the first and second apparatuses is scheduled for the second apparatus by the first apparatus.

According to some embodiments of the invention there is provided an apparatus comprising: means for receiving a first message identifying a first apparatus and a second message scheduling a time period for reply; means for sending, during the time period scheduled by the second message, a third message; and means for changing a role of the apparatus so that bi-directional data transfer is scheduled for the apparatus by another apparatus.

According to some embodiments of the invention there is provided a computer program product comprising: means operable, in response to an apparatus that stores the computer program product receiving a first message identifying another apparatus and a second message scheduling a time period, to enable sending of a third message to the another apparatus during the time period scheduled by the second message; and means for changing a role of the apparatus so that bi-directional data transfer is scheduled for the apparatus by the another apparatus.

According to some embodiments of the invention there is provided a method comprising: sending from a first apparatus to a second apparatus a first message identifying the first apparatus and a second message scheduling a time period for reply; receiving at the second apparatus the first message identifying the first apparatus and a second message scheduling a time period for reply; sending, during the time period scheduled by the second message, from the second apparatus to the first apparatus, a third message; receiving at the first apparatus during the time period scheduled by the second message the third message sent by the second apparatus; the first apparatus, in response to receiving the third message, sends a fourth message to the second apparatus and changes a role of the first apparatus so that it is operable to schedule bi-directional data transfer between the first apparatus and the second apparatus; and the second apparatus, in response to receiving the fourth message, changes a role of the second apparatus so that bi-directional data transfer between the first apparatus and the second apparatus is scheduled for the second apparatus by the first apparatus.

### BRIEF DESCRIPTION OF THE DRAWINGS

For a better understanding of the present invention reference will now be made by way of example only to the accompanying drawings in which:

FIG. 1 schematically illustrates a wireless communication system comprising a network of apparatuses;

FIG. 2 illustrates a process by which the roles of network controller and network participant can be swapped for two apparatuses; and

FIG. 3 schematically illustrates one implementation of an apparatus which software enables the apparatus to operate as the first and/or second apparatus.

### DETAILED DESCRIPTION OF EMBODIMENTS OF THE INVENTION

The Figures illustrate sending from a first apparatus 11 to a second apparatus 12 a first message (M1) 13 identifying the first apparatus 11 and a second message (M2) 14 scheduling a time period for reply; receiving at the first apparatus 11 during the time period scheduled by the second message (M2) 14 a third message (M3) 15 sent by the second apparatus 12; and in response to receiving the third message (M3) 15, changing a role of the first apparatus 11 so that it is operable to schedule bi-directional data transfer between the first apparatus 11 and the second apparatus 12.

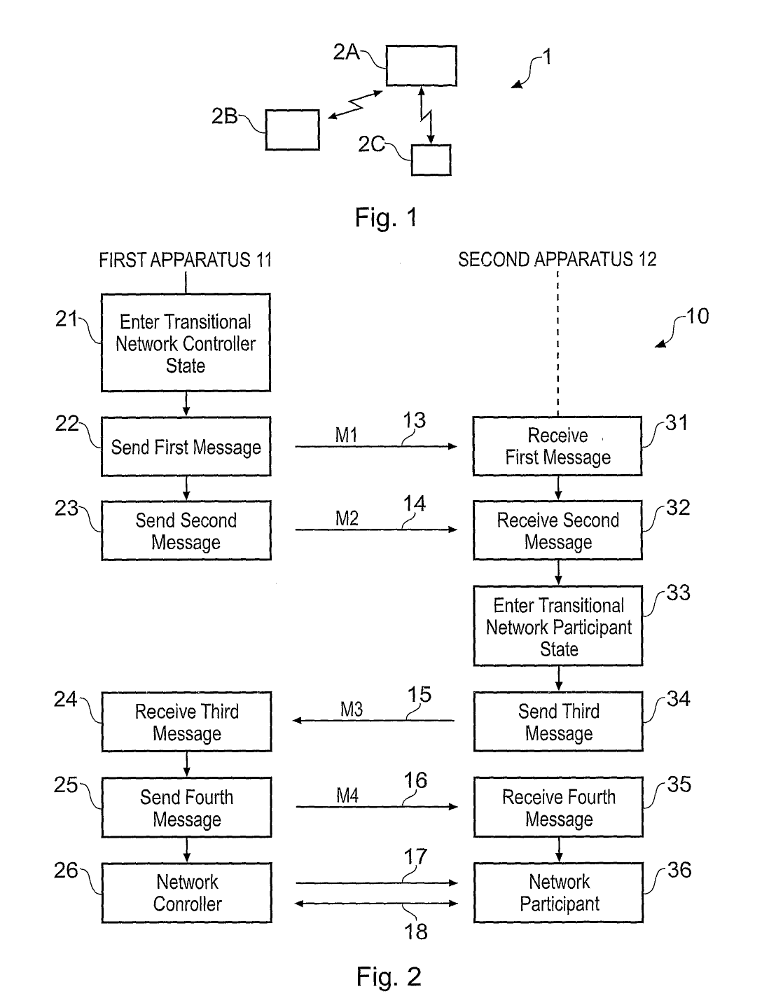

FIG. 1 schematically illustrates a wireless communication system 1 comprising a network of apparatuses 2A, 2B and 2C. The network has a star topography with the apparatus 2A at the center and the apparatuses 2B and 2C connected to the center but not each other. Although there are two peripheral apparatuses 2B, 2C this is not necessary there may be more or less peripheral apparatuses. For example, in WUSB, a network has a single host which can support up to 127 devices.

The apparatus 2A operates as a network controller and the apparatuses 2B and 2C operate as network participants. If the network is a Certified Wireless Universal Serial Bus (WUSB) network, the network controller is called a ‘host’ and the participants are called ‘devices’. If the network were a Bluetooth piconet, the network controller would be called a ‘Master’ and the participants would be called ‘Slaves’.

FIG. 2 illustrates a process 10 by which the roles of network controller and network participant can be swapped for two apparatuses.

A first apparatus 11 is initially operating as a network participant and a second apparatus 12 is initially operating as network controller. At the end of the process 10, the roles swap. The first apparatus 11 becomes network controller while the second apparatus 12 becomes network participant.

The first apparatus 11 initially enters, at step 21, a transitional network controller state. In this state, the first apparatus 11 is able to perform some of the functions of a network controller but it does not control the network. For example, in this state, the first apparatus 11 is able to send a second message 14 that schedules a time period during which it is operable to receive a message.

After the first apparatus 11 has entered the transitional network controller state, it sends a first message (M1) 13 and a second message (M2) 14 to the second apparatus 12 at steps 21 and 22 respectively.

The first message 13 is a request for a role swap. It identifies the first apparatus as the origin of the message. The second message (M2) 14 defines a communications time period when the first apparatus 11 is operable to receive a third message (M3) transmitted by the second apparatus 12.

At step 31, the second apparatus 12 which is performing the network controller role receives the first message (M1) 13 and identifies it as a request for a role swap. If the second apparatus 12 is prepared to swap roles, then the process 10 proceeds to step 32, otherwise the process 10 times out. At step 32, the second apparatus 12 listens for a second message (M2) 14.

At step 32, second apparatus 12 which is performing the network controller function receives the second message (M2) 14. It processes the second message M2 to identify the scheduled communications time period during which it can send a third message (M3) in reply and then enters, at step 33, a transitional network participant state. In this state, the second apparatus 12 is able to perform some of the functions of a network participant but it still controls the network. For example, in this state, the second apparatus 12 sends, at step 34, a third message (M3) 15 during the communications time period scheduled by the received second message (M2) 14.

If the first apparatus 11 has not received a third message (M3) by the end of the scheduled communications period, a timeout occurs and the process 10 is terminated. If, however, a third message (M3) 15 is received on schedule at step 24, the first apparatus sends, at step 35, a fourth message (M4) 16 in reply to the second apparatus 12. Then at step 26, the first apparatus 11 enters the network controller role (simultaneously exiting the network participant role).

The second apparatus 12, in response to receiving the fourth message M4 at step 35 enters, at step 36, the network participant role (simultaneously exiting the network controller role)

The roles of the first apparatus 11 and the second apparatus 12 have been switched and the process 10 terminates. The first apparatus is now, for example, operable to schedule 17 bi-directional data transfer 18 between the first apparatus 11 and the second apparatus 12.

A trigger causes the first apparatus 11 to enter, at step 21, the transitional network controller state and start the process 10. In one embodiment, the process 10 is initiated by the first apparatus 11 and the trigger is generated internally to the first apparatus 11. In another embodiment, the process 10 is initiated by the second apparatus 12 and the trigger is generated at the second apparatus and transmitted as a trigger message to the first apparatus 11. Triggers may be generated when a network is initially being set-up or, alternatively, after it has been set-up.

In a WUSB implementation, the network controller role corresponds to the host role and the network participant role corresponds to the device role.

In a WUSB network, a fast, bi-directional, isochronous wireless interface is provided between a host and one or more devices. The wireless interface operates as a logical bus that supports high speed data exchange between the host and a device. The Ultra WideBand frequency bands (3.1 to 10.6 GHz) may be used for the wireless communication channel.

WUSB uses a host scheduled, time division access (TDMA) protocol. A schedule for data communications between the host and a device is provided by a micro-scheduled management command (MMC) transmitted by the host. The MMC identifies using an information element (IE) in wireless channel allocation block WₓCTA used for channel time allocation (CTA) which of the subsequent slots are reserved for transmission of data by the host to the device, which are reserved for transmission of data by the device to the host and which (if any) are reserved for device initiated notification messages.

A WUSB device attaches to a host by sending a DN_CONNECT notification at a time specified in a W_{DNTS}CTA IE.

WUSB allows for some limited communication from a device to a host that is initiated by the device rather than the host. This communication takes the form of Notifications which are strictly predefined data structures that have a predetermined format. A Notification is sent asynchronously, point-to-point, during a communication time period allocated by the host. The time period spans a number of device notification time slots (DNTS) and a slotted aloha access system is used by a device to send a notification. The receipt of notifications by the host are typically acknowledged. Each notification message is small in size (32 bytes).

The communication time period (DNTS) is notified to a device using an information element (IE) in wireless channel allocation block W_{DNTS}CTA used for channel time allocation (CTA). The W_{DNTS}CTA IE may be included in a micro-scheduled management command (MMC) transmitted by the host or a beacon.

Distributed Media Access Control (MAC) Specification for wireless networks (WiMedia Alliance) and the High Rate Ultra Wideband PHY and MAC Standard (ECMA 368) describe beacon messages and information elements. The content of these documents is incorporated by reference, at least, in so far as it relates to beacons and application specific information elements.

A beacon is a frame comprising a header of beacon parameters and then one or more information elements (IE).

Beacons are broadcast periodically at the start of each superframe during the beacon period. Each active device can transmit a beacon and can listen for beacons during the beacon period.

An application specific information element (ASIE) is an information element that has a variable and flexible content/format and is designed for flexible transfer of different information depending upon application.

### First Embodiment

The first embodiment uses a beacon as the first message (M1) 13.

The first message (M1) 13 corresponds to a beacon comprising a newly defined ASIE (“connect to me”) that includes the MAC address of the first apparatus 11.

The second message corresponds to a MMC containing a W_{DNTS}CTA IE. This indicates DNTS that may be used by the second apparatus 12 for sending Notifications to the first apparatus 11.

The third message corresponds to a DN_CONNECT notification. It is sent to the first apparatus 11 during the DNTS using a slotted aloha access method.

The fourth message corresponds to a Connect Acknowledge IE.

This embodiment can be implemented without changing the Certified Wireless USB standard as the flexibility of the ASIE is used to define a new ASIE for requesting role switching. However, unless all manufactures agree to a common specification of the newly defined ‘connect to me’ ASIE, the process 10 will not operate for all apparatuses.

### Second Embodiment

The second embodiment uses a newly defined Notification as the first message (M1) 13.

The first message (M1) 13 corresponds to newly defined ‘connect to me’ Notification that includes the MAC address of the first apparatus 11. The first apparatus 11 additionally sends its own beacon message.

Notification messages are point-to-point and are schedule. This contrasts with beacon messages which are broadcast and periodic.

This implementation could be implemented by changing the Certified Wireless USB standard to define the new ‘connect to me’ Notification.

### Triggers

When an apparatus wants to form a network with another apparatus, it searches for the beacon of that other apparatus and uses a W_{DNTS}CTA IE within the received beacon to schedule the transmission of a DN_CONNECT Notification. The acknowledgement of DN_CONNECT by the another apparatus forms the network.

However, the connecting apparatus will, by default operate as the device and the beaconing apparatus will, by default, operate as the host. The above described process 10 may be performed when the beacon of the another beaconing apparatus is received (before the transmission of DN_CONNECT) or, alternatively, after the network has been formed. In these circumstances, the connecting apparatus triggers the process 10.

The host can also trigger the process 10 either before the network is formed or after the network is formed. The host adds a new ASIE to its beacon. This could be a standardized ASIE or a proprietary ASIE such as, for example, an ‘I will connect to you’ ASIE that indicates that the host will connect to the device. The ASIE operates as the trigger.

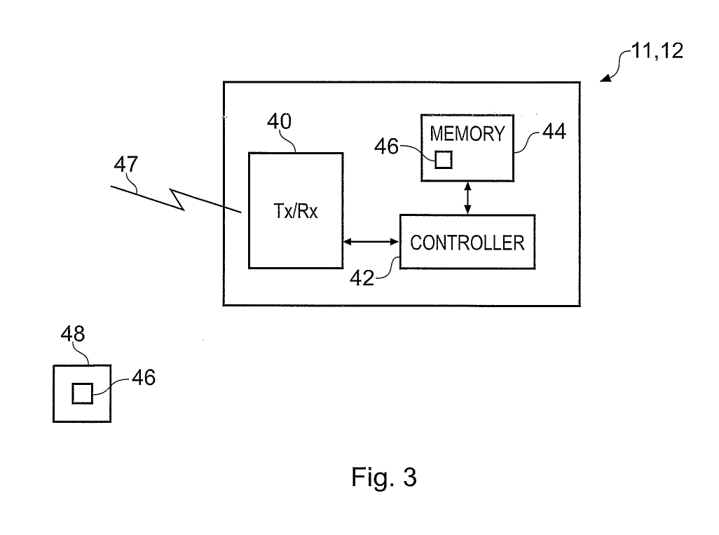

The functionality that enables the first apparatus 11 to participate in the process 10 may be provided by hardware, firmware or software. The functionality that enables the second apparatus 11 to participate in the process 10 may be provided by hardware, firmware or software. FIG. 3 schematically illustrates one implementation of an apparatus 11, 12 in which the necessary functionality is provided by software. It should be appreciated that a particular apparatus depending on circumstance may operate as the first apparatus 11 and the second apparatus 12. Such an apparatus is able to switch modes and to have its mode switched.

The apparatus 10, 11 comprises radio frequency (RF) circuitry 40 for wireless communication, a controller 42 and a memory 44. The controller 42 which may, for example, be one or more processors is connected to read from and write to the memory 44. It is also connected to provide data to the RF circuitry 40 and receive data from the RF circuitry.

The memory 44 stores computer program instructions 46 that control the operation of the apparatus when loaded into the controller 42. The computer program instructions 46 provide the logic and routines that enables the apparatus to perform the functions of the first apparatus 11 in process 10 illustrated in FIG. 2 46 and/or to perform the functions of the second apparatus 12 in process 10 illustrated in FIG. 2.

The computer program instructions may arrive at the apparatus as a computer program product via an electromagnetic carrier signal 47 or be copied from a physical entity 48 such as a computer program product, a memory device or a record medium such as a CD-ROM or DVD.

The computer program product can enable the apparatus t perform as the first apparatus 11. The computer program product may comprise: means for enabling transmission of a first message identifying an apparatus storing the computer program product and a second message scheduling a time period for reply; and means for enabling the apparatus to schedule bi-directional data transfer in response to receipt by the apparatus of a third message during the time period scheduled by the second message.

The computer program product can enable the apparatus t perform as the first apparatus 11. The computer program product may comprise: means operable, in response to an apparatus that stores the computer program product receiving a first message identifying another apparatus and a second message scheduling a time period, to enable sending of a third message to the another apparatus during the time period scheduled by the second message; and means for changing a role of the apparatus so that bi-directional data transfer is scheduled for the apparatus by the another apparatus.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
sending from a first apparatus to a second apparatus a first message identifying the first apparatus and a second message scheduling a time period for reply;
receiving at the first apparatus during the time period scheduled by the second message a third message sent by the second apparatus; and
in response to receiving the third message, changing a role of the first apparatus so that it is operable to schedule bi-directional data transfer between the first apparatus and the second apparatus.

2. A method as claimed in claim 1, wherein changing the role of the first apparatus changes the first apparatus from a network participant to a network controller.

3-4. (canceled)

5. A method as claimed in claim 1, wherein the first and second messages are sent separately and the first, second and third messages are sent wirelessly.

6. (canceled)

7. A method as claimed in claim 1, wherein the first message is formed by adapting a periodically broadcast message to identify the first apparatus.

8. A method as claimed in claim 1, wherein the first message is a beacon.

9-10. (canceled)

11. A method as claimed in claim 1, wherein the first message is a scheduled, point-to-point transmission.

12-14. (canceled)

15. A method as claimed in claim 1, wherein the first apparatus, in response to receiving the third message, sends a fourth message for swapping the roles of the first and second apparatuses.

16. A method as claimed in claim 1, triggered by a message received at the first apparatus from the second apparatus.

17. An apparatus comprising:
at least one processor;
and at least one memory storing computer program instructions;
the at least one memory and the computer program instructions being configured to, with the at least one processor, cause the apparatus at least to perform;
transmitting a first message identifying the apparatus and a second message scheduling a time period for reply;
receiving a third message during the time period scheduled by the second message; and
enabling the apparatus in response to receiving the third message, to schedule bi-directional data transfer.

18. A computer-readable medium having stored thereon a computer program product comprising computer program instructions that, when executed by at least one processor, cause an apparatus to perform:
transmitting a first message identifying an apparatus and a second message scheduling a time period for reply; and
scheduling bi-directional data transfer in response to receipt by the apparatus of a third message during the time period scheduled by the second message.

19-31. (canceled)

32. An apparatus comprising:
at least one processor;
and at least one memory storing computer program instructions;
the at least one memory and the computer program code configured to, with the at least one processor, cause the apparatus at least to perform:
receiving a first message identifying a first apparatus and a second message scheduling a time period for reply;
sending, during the time period scheduled by the second message, a third message; and
changing a role of the apparatus so that bi-directional data transfer is scheduled for the apparatus by another apparatus.

33. A computer readable medium as claimed in claim 18, wherein the computer program instructions, when executed by at least one processor, cause the apparatus to change a role of the apparatus so that it is operable to schedule bi-directional data.

34. A computer readable medium as Claimed in claim 33, wherein changing the role of the apparatus changes the apparatus from a network participant to a network controller.

35. An apparatus as claimed in claim 32, wherein the first and second messages are received separately.

36. A method as claim in claim 1, further comprising:
receiving at the second apparatus the first message identifying the first apparatus and the second message scheduling a time period for reply;
sending, during the time period scheduled by the second message, from the second apparatus to the first apparatus, the third message; and
changing a role of the second apparatus so that bi-directional data transfer between the first and second apparatuses is scheduled for the second apparatus by the first apparatus.

37. An apparatus as claimed in claim 17, wherein the at least one memory and the computer program instructions are configured to, with the at least one processor, cause the apparatus to change a role of the apparatus so that it is operable to schedule bi-directional data.

38. An apparatus as claimed in claim 37, wherein changing the role of the apparatus changes the apparatus from a network participant to a network controller.

39. An apparatus as claimed in claim 17, wherein the at least one memory and the computer program instructions are configured to, with the at least one processor, cause the apparatus to send the first and second messages separately.

40. An apparatus as claimed in claim 17, wherein the first message is a beacon.

41. An apparatus as claimed in claim 17, wherein the first message is a scheduled, point-to-point transmission.
